(19) United States
(12) Patent Application Publication
(10) Pub. No.: US 2024/0241851 A1
(43) Pub. Date: Jul. 18, 2024

(54) DATA TRANSMISSION SYSTEM AND DATA TRANSMISSION METHOD

(71) Applicant: AIXlink Ltd., Sichuan (CN)

(72) Inventor: Jian-Shiang Fang, Taipei City (TW)

(73) Assignee: AIXlink Ltd., Sichuan (CN)

(21) Appl. No.: 18/460,701

(22) Filed: Sep. 5, 2023

(30) Foreign Application Priority Data
Jan. 16, 2023 (CN) 202310086090.X

(51) Int. Cl. G06F 13/42

(52) U.S. Cl. CPC G06F 13/4282; G06F 2213/40

(57) ABSTRACT

A data transmission system includes a master device and a slave device group. The slave device group includes a first slave device and a second slave device. The master device, the first slave device, and the second slave device are sequentially connected in series along a data transmission path. The master device transmits a streaming signal to the slave device group, and the slave device group analyzes the streaming signal to identify which one of the first slave device and the second slave device is a target slave device for performing an access operation on the streaming signal. The target slave device generates a streaming response signal based on the streaming signal and transmits the streaming response signal to the master device. The master device analyzes the streaming response signal to identify the streaming response signal is generated by the first slave device or the second slave device.

### CROSS-REFERENCE TO RELATED APPLICATION

This application claims the priority benefit of China application serial no. 202310086090.X, filed on Jan. 16, 2023. The entirety of the above-mentioned patent application is hereby incorporated by reference herein and made a part of this specification.

### BACKGROUND

### Technical Field

The disclosure relates to a data transmission system, and more particularly, relates to a data transmission system and a data transmission method which transmit data through a serial peripheral interface (SPI).

### Description of Related Art

The serial peripheral interface (SPI) is a master-slave communication interface for synchronous serial communication. In general, when a master device connects to a plurality of slave devices via the serial peripheral interface, the master device and a target slave device may be identified with each other for communication by pull down a logic level of a chip select signal (CS signal) corresponding to the target slave device. Since each of the plurality of slave devices corresponds to a specific CS signal, the master device needs to dispose multiple chip select pins (CS pins) for identifying each of the plurality of slave devices, respectively. However, it is necessary to provide a larger chip area for the master device to dispose multiple CS pins, which increases the cost of a data transmission system.

In order to reduce the number of CS pins disposed on the master device, some improved schemes use a data communication pin (i.e. MOSI) to perform an identification operation between a master device and a target slave device. For example, FIG. 1 is a block diagram of a conventional SPI communication system including a plurality of slave device. As shown in FIG. 1, the master device may transmit identification signals to a plurality of slave device to identify a target slave device. If an identification number included in a specific slave device matches with an identification signal provided by the master device, the master device may determine the specific slave device as the target slave device. However, the communication system in FIG. 1 transmits data in parallel, which induces cross talk effects between adjacent signal lines, thereby reducing the data transmission efficiency between the master device and multiple slave devices.

### SUMMARY

The disclosure provides a data transmission system and a data transmission method, which performs an identification operation between a master device and a target slave device without using a CS pin. In addition, the data transmission system and the data transmission method of the disclosure may enhance the data transmission efficiency between the master device and multiple slave devices.

In an embodiment of the disclosure, a data transmission system is provided. The data transmission system includes a master device and a slave device group. The slave device group includes a first slave device and a second slave device. The master device, the first slave device, and the second slave device are sequentially connected in series along a data transmission path. The master device is configured to transmit a streaming signal to the slave device group, and the slave device group is configured to analyze the streaming signal to identify which one of the first slave device and the second slave device is a target slave device for performing an access operation on the streaming signal. The target slave device is configured to generate a streaming response signal based on the streaming signal and transmit the streaming response signal to the master device. The master device is configured to analyze the streaming response signal to identify the streaming response signal is generated by the first slave device or the second slave device.

In another embodiment of the disclosure, a data transmission system is provided. The data transmission system includes a master device and a slave device group. The slave device group includes a first slave device and a second slave device. The master device, the first slave device, and the second slave device are sequentially connected in series along a data transmission path. The master device is configured to respectively transmit a first streaming signal and a second streaming signal to the slave device group at different time points. The slave device group is configured to analyze the first streaming signal and the second streaming signal to identify that using the first slave device to perform a first access operation on the first streaming signal and using the second slave device to perform a second access operation on the second streaming signal. The first slave device is configured to generate a first streaming response signal based on the first streaming signal and transmit the first streaming response signal to the master device at a first time point. The second slave device is configured to generate a second streaming response signal based on the second streaming signal and transmit the second streaming response signal to the master device at a second time point. The master device is configured to analyze the first streaming response signal and the second streaming response signal to identify that the first streaming response signal is generated from the first slave device and identify that the second streaming response signal is generated from the second slave device, respectively.

In an embodiment of the disclosure, a method for transmitting data between a master device and a slave device group is provided. The slave device group includes a first slave device and a second slave device. The master device, the first slave device, and the second slave device are sequentially connected in series along a data transmission path. The method includes: respectively transmitting a first streaming signal and a second streaming signal to the slave device group at different time points by the master device, and analyzing the first streaming signal and the second streaming signal by the slave device group so as to identify that using the first slave device to perform a first access operation on the first streaming signal and using the second slave device to perform a second access operation on the second streaming signal; generating a first streaming response signal based on the first streaming signal by the first slave device, and transmitting the first streaming response signal to the master device at a first time point; generating a second streaming response signal based on the second streaming signal by the second slave device, and transmitting the second streaming response signal to the master device at a second time point; and analyzing the first streaming response signal and the second streaming response signal by the master device to respectively identify that the first streaming response signal is generated from the first slave device and identify that the second streaming response signal is generated from the second slave device.

Based on the above, in the embodiments of the disclosure, the data transmission system performs an identification operation between a master device and a target slave device by using a streaming signal transmitted from the mater device to the slave device group. In addition, the master device in the embodiments of the disclosure determines the one-to one mapping operation each of the slave devices and each of the streaming response signal, so that the master device performs an access operation on the data transmitted by a specific slave device. Since the master device and the slave device group are connected in series along a data transmission path based on the transmission operations of the streaming signals and the streaming response signals, the data transmission system and the data transmission method of the disclosure do not induce cross talk effects. Therefore, the data transmission system and the data transmission method of the disclosure may enhance the data transmission efficiency between the master device and multiple slave devices.

To make the afore-mentioned features more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a conventional SPI communication system including a plurality of slave device.

FIG. 2 is a block diagram of a data transmission system according to an embodiment of the disclosure.

FIG. 3 is a schematic diagram of a streaming signal and a streaming response signal according to an embodiment of the disclosure.

FIG. 4 is a block diagram of a data transmission system according to another embodiment of the disclosure.

FIG. 5 depicts a flow chart of a data transmission method according to an embodiment of the disclosure.

FIG. 6A is a schematic diagram of a first streaming signal and a second streaming signal according to an embodiment of the disclosure.

FIG. 6B is a schematic diagram of a first streaming response signal and a second streaming response signal according to an embodiment of the disclosure.

FIG. 7 is a block diagram of a data transmission system according to another embodiment of the disclosure.

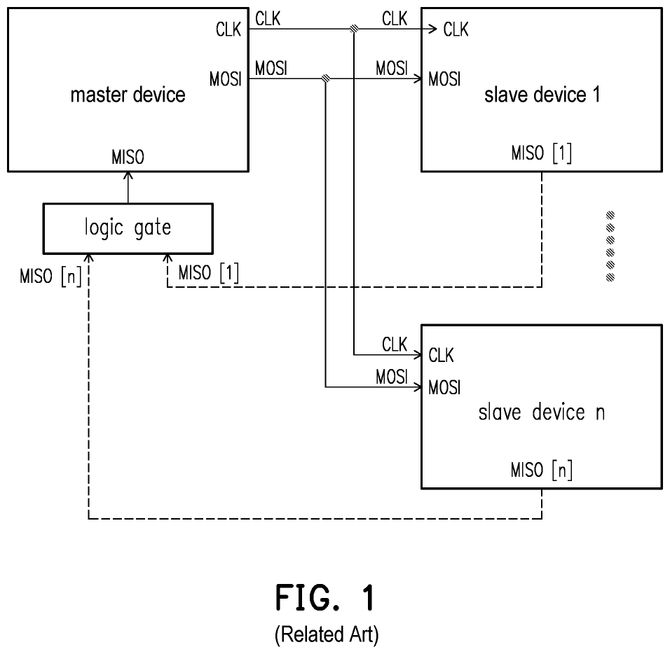

### DESCRIPTION OF THE EMBODIMENTS

The term “couple (or connect)” herein (including the claims) are used broadly and encompass direct and indirect connection or coupling means. For example, if the disclosure describes a first apparatus being coupled (or connected) to a second apparatus, then it should be interpreted that the first apparatus can be directly connected to the second apparatus, or the first apparatus can be indirectly connected to the second apparatus through other devices or by a certain coupling means. Moreover, elements/components/steps with same reference numerals represent same or similar parts in the drawings and embodiments. Elements/components/steps with the same reference numerals or symbols in different embodiments may be mutually referenced to the related description.

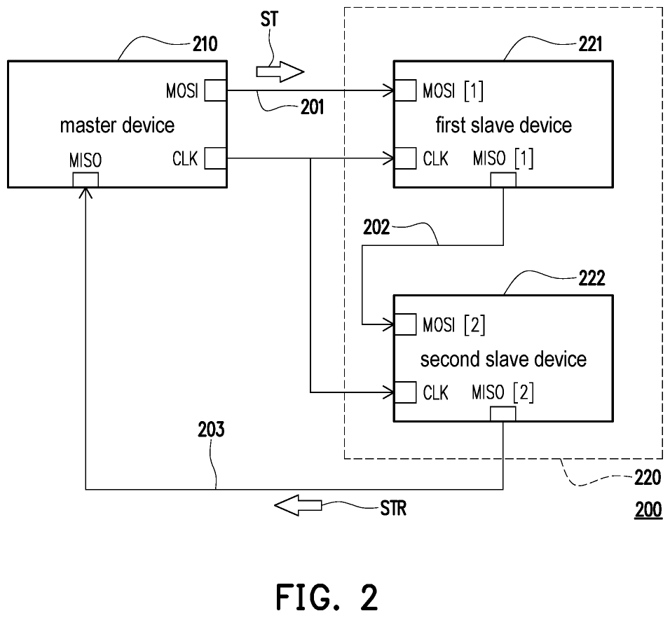

FIG. 2 is a block diagram of a data transmission system according to an embodiment of the disclosure. Referring to FIG. 2, the data transmission system 200 includes a master device 210 and a slave device group 220. The slave device group 220 may include a first slave device 221 and a second slave device 222. The master device 210, the first slave device 221, and the second slave device 222 are sequentially connected in series along a data transmission path. The data transmission path in FIG. 2 includes a sub-data transmission path 201 connecting between the master device 210 and the first slave device 221, a sub-data transmission path 202 connecting between the first slave device 221 and the second slave device 222, and a sub-data transmission path 203 connecting between the second slave device 222 and the master device 210. In the embodiment of FIG. 2, the master device 210 may transmit a same clock signal to the first slave device 221 and the second slave device 222 in parallel via the clock pin CLK. Therefore, the master device 210 and the slave device group 220 may use the same clock signal for data communication. When the master device 210 intends to transmit data to the slave device group 220, the master device 210 may transmit a streaming signal ST to the slave device group 220 via a first data communication pin MOSI of the master device 210. The first slave device 221 may receive the streaming signal ST via a first data communication pin MOSI [1] of the first slave device 221, and the first slave device 221 may transmit the streaming signal ST to a first data communication pin MOSI [2] of the second slave device 222 via a second data communication pin MISO [1] of the first slave device 221. The first slave device 221 and the second slave device 222 of the slave device group 220 may respectively analyze the streaming signal ST to identify which one of the first slave device 221 and the second slave device 222 is a target slave device for performing an access operation on the streaming signal ST.

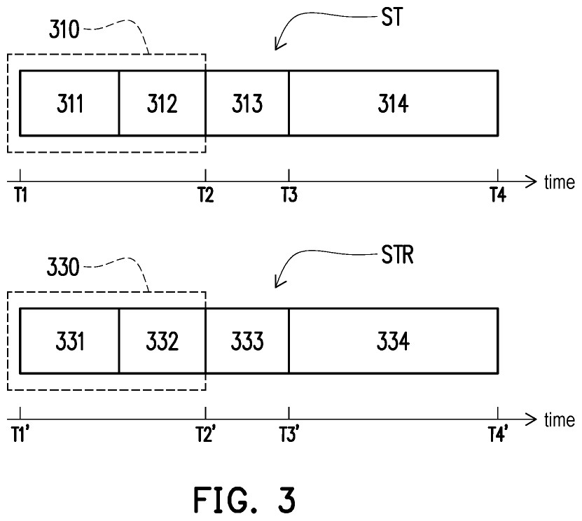

Specifically, FIG. 3 is a schematic diagram of a streaming signal and a streaming response signal according to an embodiment of the disclosure. In FIG. 3, the streaming signal ST may include feature information 310 and data information 314. For example, the feature information 310 may include feature bits selecting from a group of digital bits “0” and digital bits “1”. Referring to FIG. 2 and FIG. 3, when the first slave device 221 and the second slave device 222 respectively receives the streaming signal ST, the first slave device 221 and the second slave device 222 may use their build-in processors (not shown) to analyze the feature information 310 of the streaming signal ST to determine that which one of the first slave device 221 and the second slave device 222 corresponds to the feature information 310 of the streaming signal ST. It is assumed that the feature information 310 of the streaming signal ST corresponds to the first slave device 221. Then, the first slave device 221 may serve as the target slave device for performing an access operation (e.g. read operation or write operation) on the data information 314 of the streaming signal ST.

Preferably, the feature information 310 may be transmitted before the data information 314. For example, it is assumed that the feature information 310 of the streaming signal ST corresponds to the first slave device 221. As shown in FIG. 3, the transmission duration of the streaming signal ST is arranged between the time point T1 and the time point T4. A time interval for transmitting the feature information 310 is disposed between the time point T1 and the time point T2, and a time interval for transmitting the data information 314 is disposed between the time point T3 and the time point T4. Since the feature information 310 is transmitted earlier than the data information 314, the first slave device 221 may receive the feature information 310 earlier than the second slave device 222. Therefore, the first slave device 221 may be defined as the target slave device. The first slave device 221 may receive the data information 314 after receiving the feature information 310, and the first slave device 221 may perform an access operation (e.g. read operation or write operation) on the data information 314 of the streaming signal ST. It should be noted that the data information 314 of the streaming signal ST represents the valid data.

In the embodiment of FIG. 3, the feature information 310 of the streaming signal ST may include command information 311 and address information 312. The command information 311 may define an accessing type of the data information 314, such as a read operation or a write operation. The address information 312 may define an accessing range of the data information 314. In another embodiment, the feature information 310 may be a specific information which does not include the command information 311 and the address information 312, and a time interval for transmitting the feature information 310 may be arranged before a time interval for transmitting the command information 311 (not shown). Referring to FIG. 3, the streaming signal ST may further include error checking information 313. The error checking information 313 may check that whether an error occurs in the data information 314 during transmitting the streaming signal ST.

Referring to FIG. 2, after one of the first slave device 221 and the second slave device 222 is defined as the target slave device, the target slave device (i.e. first slave device 221 or second slave device 222) may generate a streaming response signal STR based on the streaming signal ST, and transmit the streaming response signal STR to the master device 210. The master device 210 may analyze the streaming response signal STR to identify which one of the first slave device 221 and the second slave device 222 generates the streaming response signal STR. Specifically, referring to FIG. 3, the streaming response signal STR may include feature information 330 and data information 334. For example, the feature information 330 may include feature bits selecting from a group of digital bits “0” and digital bits “1”. When the master device 210 receives the streaming response signal STR via the sub-data transmission path 203, the master device 210 may analyze the feature information 330 of the streaming response signal STR to determine that which one of the first slave device 221 and the second slave device 222 corresponds to the feature information 330 of the streaming response signal STR. It is assumed that the feature information 310 of the streaming signal ST corresponds to the first slave device 221. Then, he first slave device 221 may generate the streaming response signal STR based on the streaming signal ST, and transmit the streaming response signal STR to the second slave device 222 via the sub-data transmission path 202. The second slave device 222 may transmit the streaming response signal STR generated by the first slave device 221 to the master device 210. Therefore, the master device 210 may determine that the streaming response signal STR is generated by the first slave device 221 by identifying the feature information 330 of the streaming response signal STR. Then, the master device 210 may perform an access operation (e.g. read operation or write operation) on the data information 334 of the streaming response signal STR.

Preferably, the feature information 330 may be transmitted before the data information 334. For example, it is assumed that the feature information 330 of the streaming response signal STR corresponds to the first slave device 221. As shown in FIG. 3, the transmission duration of the streaming response signal STR is arranged between the time point T1′ and the time point T4′. A time interval for transmitting the feature information 330 is disposed between the time point T1′ and the time point T2′, and a time interval for transmitting the data information 334 is disposed between the time point T3′ and the time point T4′. Since the feature information 330 is transmitted earlier than the data information 334, the master device 210 may firstly receive the feature information 330 corresponding to the first slave device 221. The master device 210 may receive the data information 334 after receiving the feature information 330, and the master device 210 may perform an access operation (e.g. read operation or write operation) on the data information 334 of the streaming response signal STR. It should be noted that the data information 334 of the streaming response signal STR represents the valid data.

In the embodiment of FIG. 3, the feature information 330 of the streaming response signal STR may include command information 331 and address information 332. The command information 331 may define an accessing type of the data information 334, such as a read operation or a write operation. The address information 332 may define an accessing range of the data information 334. In another embodiment, the feature information 330 may be a specific information which does not include the command information 331 and the address information 332, and a time interval for transmitting the feature information 330 may be arranged before a time interval for transmitting the command information 331 (not shown). Referring to FIG. 3, the streaming response signal STR may further include error checking information 333. The error checking information 333 may check that whether an error occurs in the data information 334 during transmitting the streaming response signal STR via the sub-data transmission path 203.

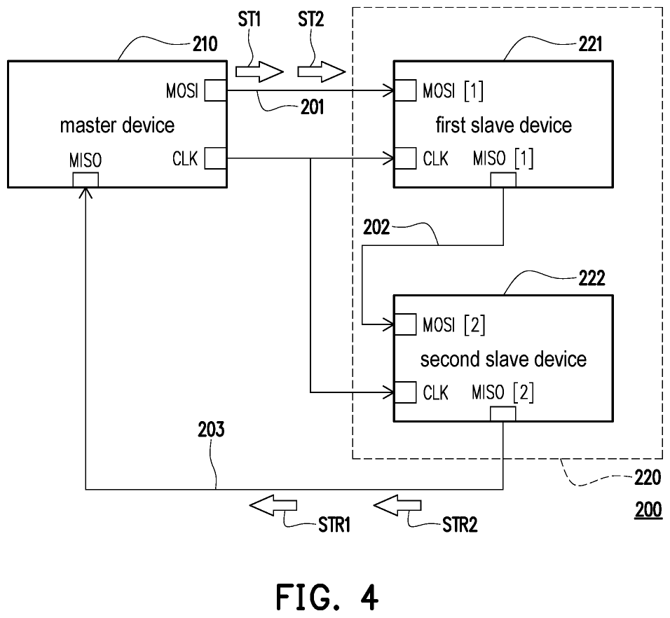

FIG. 4 is a block diagram of a data transmission system according to another embodiment of the disclosure. Referring to FIG. 4, the data transmission system 200 includes a master device 210 and a slave device group 220. The slave device group 220 may include a first slave device 221 and a second slave device 222. The master device 210, the first slave device 221, and the second slave device 222 are sequentially connected in series along a data transmission path. The data transmission path in FIG. 4 includes a sub-data transmission path 201 connecting between the master device 210 and the first slave device 221, a sub-data transmission path 202 connecting between the first slave device 221 and the second slave device 222, and a sub-data transmission path 203 connecting between the second slave device 222 and the master device 210. In the embodiment of FIG. 4, the master device 210 may transmit a same clock signal to the first slave device 221 and the second slave device 222 in parallel via the clock pin CLK. Therefore, the master device 210 and the slave device group 220 may use the same clock signal for data communication. When the master device 210 intends to transmit data to the slave device group 220, the master device 210 may respectively transmit a first streaming signal ST1 and a second streaming signal ST2 to the slave device group 220 at different time points via a first data communication pin MOSI of the master device 210. The first slave device 221 may receive the first streaming signal ST1 and the second streaming signal ST2 via a first data communication pin MOSI [1] of the first slave device 221, and the first slave device 221 may respectively transmit the first streaming signal ST1 and the second streaming signal ST2 to a first data communication pin MOSI [2] of the second slave device 222 via a second data communication pin MISO [1] of the first slave device 221. The first slave device 221 and the second slave device 222 of the slave device group 220 may respectively analyze the first streaming signal ST1 and the second streaming signal ST2 to decide how to perform access operations on the first streaming signal ST1 and the second streaming signal ST2.

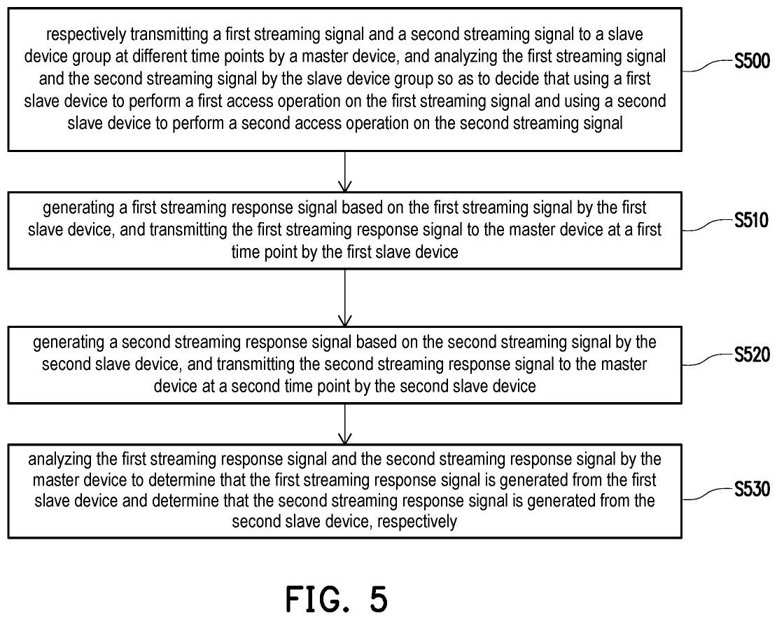

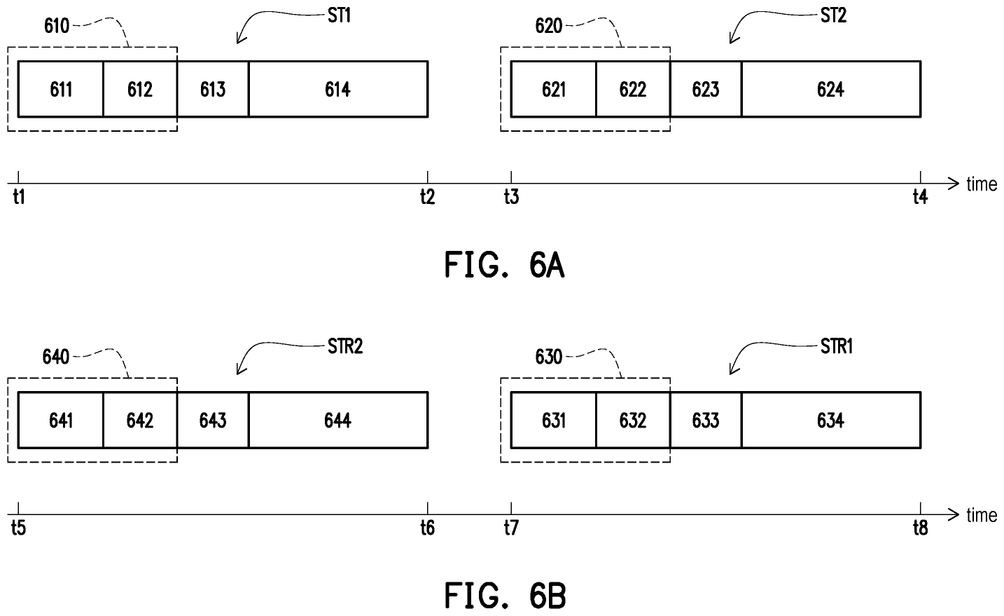

Specifically, referring to FIG. 4, FIG. 5, and FIG. 6A. FIG. 5 depicts a flow chart of a data transmission method according to an embodiment of the disclosure, and FIG. 6A is a schematic diagram of a first streaming signal and a second streaming signal according to an embodiment of the disclosure. In FIG. 6A, the first streaming signal ST1 may include feature information 610 and data information 614, and the second streaming signal ST2 may include feature information 620 and data information 624. Referring to FIG. 4, FIG. 5 and FIG. 6A, in step S500, the master device 210 may transmit the first streaming signal ST1 to the slave device group 220 at the time point t1, and transmit the second streaming signal ST2 to the slave device group 220 at the time point t3. When the first slave device 221 receives the first streaming signal ST1 and the second streaming signal ST2, the first slave device 221 may use its build-in processor (not shown) to analyze the feature information 610 of the first streaming signal ST1 and analyze the feature information 620 of the second streaming signal ST2. Therefore, the first slave device 221 may determine that which one of the feature information 610 and the feature information 620 corresponds to the first slave device 221. It is assumed that the feature information 610 of the first streaming signal ST1 corresponds to the first slave device 221. Then, the first slave device 221 may perform an access operation (e.g. read operation or write operation) on the data information 614 of the first streaming signal ST1.

Similarly, when the second slave device 222 receives the first streaming signal ST1 and the second streaming signal ST2, the second slave device 222 may use its build-in processor (not shown) to analyze the feature information 610 of the first streaming signal ST1 and analyze the feature information 620 of the second streaming signal ST2. Therefore, the second slave device 222 may determine that which one of the feature information 610 and the feature information 620 corresponds to the second slave device 222. It is assumed that the feature information 620 of the second streaming signal ST2 corresponds to the second slave device 222. Then, the second slave device 222 may perform an access operation (e.g. read operation or write operation) on the data information 624 of the second streaming signal ST2.

FIG. 6B is a schematic diagram of a first streaming response signal and a second streaming response signal according to an embodiment of the disclosure. In FIG. 6B, the first streaming response signal STR1 may include feature information 630 and data information 634, and the second streaming response signal STR2 may include feature information 640 and data information 644. Referring to FIG. 4, FIG. 5 and FIG. 6B, in step S510, the first slave device 221 may generate the first streaming response signal STR1 based on the first streaming signal ST1, and transmit the first streaming response signal STR1 to the second slave device 222 via the sub-data transmission path 202. The second slave device 222 may transmit the first streaming response signal STR1 to the master device 210 at the time point t7 via the sub-data transmission path 203. In step S520, the second slave device 222 may generate the second streaming response signal STR2 based on the second streaming signal ST2, and transmit the second streaming response signal STR2 to the master device 210 at the time point t5 via the sub-data transmission path 203.

In step S530, the master device 210 may analyze the feature information 630 of the first streaming response signal STR1 to determine that which one of the first slave device 221 and the second slave device 222 corresponds to the feature information 630 of the first streaming response signal STR1. In step S530, the master device 210 may further analyze the feature information 640 of the second streaming response signal STR2 to determine that which one of the first slave device 221 and the second slave device 222 corresponds to the feature information 640 of the second streaming response signal STR2. Based on the above analyses performed on the first streaming response signal STR1 and the second streaming response signal STR2, the master device 210 may determine that the first streaming response signal STR1 is generated from the first slave device 221, and the second streaming response signal STR2 is generated from the second slave device 222. Therefore, the master device 210 may perform a first access operation (e.g. read operation or write operation) on the data information 634 of the first streaming response signal STR1, and the master device 210 may perform a second access operation (e.g. read operation or write operation) on the data information 644 of the second streaming response signal STR2.

Referring to FIG. 6A, the first streaming signal ST1 further include error checking information 613, and the feature information 610 of the first streaming signal ST1 may include command information 611 and address information 612. The error checking information 613 may check that whether an error occurs in the data information 614 during transmitting the first streaming signal ST1. The command information 611 may define an accessing type of the data information 614, such as a read operation or a write operation. The address information 612 may define an accessing range of the data information 614. Similarly, the second streaming signal ST2 in FIG. 6A further include error checking information 623, and the feature information 620 of the second streaming signal ST2 may include command information 621 and address information 622. The error checking information 623 may check that whether an error occurs in the data information 624 during transmitting the second streaming signal ST2. The command information 621 may define an accessing type of the data information 624, such as a read operation or a write operation. The address information 622 may define an accessing range of the data information 624. In the embodiment of FIG. 6A, the command information 611 of the first streaming signal ST1 may be the same as (or different from) the command information 621 of the second streaming signal ST2. The combinations of various information demonstrated in the first streaming signal ST1 and the second streaming signal ST2 may include the related descriptions of the streaming signal ST shown in FIG. 3.

Referring to FIG. 6B, the first streaming response signal STR1 further include error checking information 633, and the feature information 630 of the first streaming response signal STR1 may include command information 631 and address information 632. The error checking information 633 may check that whether an error occurs in the data information 634 during transmitting the first streaming response signal STR1. The command information 631 may define an accessing type of the data information 634, such as a read operation or a write operation. The address information 632 may define an accessing range of the data information 634. Similarly, the second streaming response signal STR2 in FIG. 6B further include error checking information 643, and the feature information 640 of the second streaming response signal STR2 may include command information 641 and address information 642. The error checking information 643 may check that whether an error occurs in the data information 644 during transmitting the second streaming response signal STR2. The command information 641 may define an accessing type of the data information 644, such as a read operation or a write operation. The address information 642 may define an accessing range of the data information 644. In the embodiment of FIG. 6B, the command information 631 of the first streaming response signal STR1 may be the same as (or different from) the command information 641 of the second streaming response signal STR2. The combinations of various information demonstrated in the first streaming response signal STR1 and the second streaming response signal STR2 may include the related descriptions of the streaming response signal STR shown in FIG. 3.

Referring to FIG. 4, the first streaming signal ST1 and the second streaming signal ST2 do not overlap with each other on the sub-data transmission path 201, and the first streaming response signal STR1 and the second streaming response signal STR2 do not overlap with each other on the sub-data transmission path 203. In other words, a time interval for transmitting the first streaming signal ST1 is separated from a time interval for transmitting the second streaming signal ST2. In addition, a time interval for transmitting the first streaming response signal STR1 is separated from a time interval for transmitting the second streaming response signal STR2. For example, as shown in FIG. 6A, a time interval for transmitting the first streaming signal ST1 is disposed between the time point t1 and the time point t2, and a time interval for transmitting the second streaming signal ST2 is disposed between the time point t3 and the time point t4. Therefore, the first streaming signal ST1 and the second streaming signal ST2 do not overlap with each other on the sub-data transmission path 201. Moreover, as shown in FIG. 6B, a time interval for transmitting the first streaming response signal STR1 is disposed between the time point t7 and the time point t8, and a time interval for transmitting the second streaming response signal STR2 is disposed between the time point t5 and the time point t6. Therefore, the first streaming response signal STR1 and the second streaming response signal STR2 do not overlap with each other on the sub-data transmission path 203. It should be noted that the time points t1˜t4 shown in FIG. 6A and the time points t5˜t8 shown in FIG. 6B are depicted for illustration only. The disclosure does not limit the transmitting sequences of the first streaming signal ST1 and the second streaming signal ST2, and does not limit the transmitting sequences of the first streaming response signal STR1 and the second streaming response signal STR2.

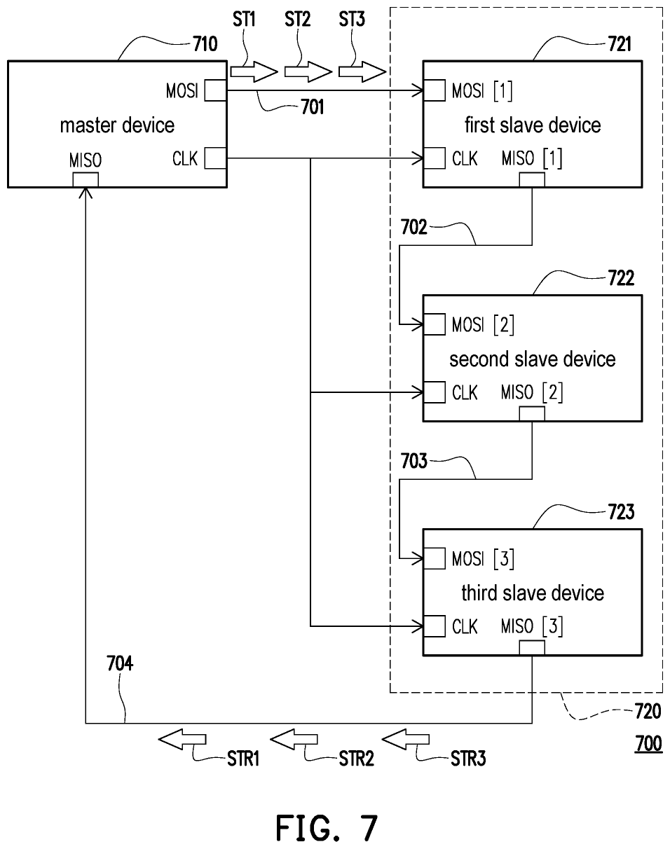

FIG. 7 is a block diagram of a data transmission system according to another embodiment of the disclosure. Referring to FIG. 7, the data transmission system 700 includes a master device 710 and a slave device group 720. The slave device group 720 may include a first slave device 721, a second slave device 722, and a third slave device 723. The master device 710, the first slave device 721, a second slave device 722, and a third slave device 723 are sequentially connected in series along a data transmission path. The data transmission path in FIG. 7 includes a sub-data transmission path 701 connecting between the master device 710 and the first slave device 721, a sub-data transmission path 702 connecting between the first slave device 721 and the second slave device 722, a sub-data transmission path 703 connecting between the second slave device 722 and the third slave device 723, and a sub-data transmission path 704 connecting between the third slave device 723 and the master device 710. In the embodiment of FIG. 7, the master device 710 may transmit a same clock signal to the first slave device 721, the second slave device 722, and the third slave device 723 in parallel via the clock pin CLK. Therefore, the master device 710 and the slave device group 720 may use the same clock signal for data communication.

When the master device 710 intends to transmit data to the slave device group 720, the master device 710 may respectively transmit a first streaming signal ST1, a second streaming signal ST2, and a third streaming signal ST3 to the slave device group 720 at different time points via a first data communication pin MOSI of the master device 710. The first slave device 221 may receive the first streaming signal ST1, a second streaming signal ST2, and a third streaming signal ST3 via a first data communication pin MOSI [1] of the first slave device 221, and the first slave device 221 may respectively transmit the first streaming signal ST1, a second streaming signal ST2, and a third streaming signal ST3 to a first data communication pin MOSI [2] of the second slave device 722 via a second data communication pin MISO [1] of the first slave device 721. The second slave device 722 may respectively transmit the first streaming signal ST1, a second streaming signal ST2, and a third streaming signal ST3 to a first data communication pin MOSI [3] of the third slave device 723 via a second data communication pin MISO [2] of the second slave device 722. In the slave device group 720, the first slave device 721, the second slave device 722, and the third slave device 723. may respectively analyze the first streaming signal ST1, the second streaming signal ST2, and the third streaming signal ST3 to decide that using the first slave device 721 to perform a first access operation on the first streaming signal ST1, using the second slave device 722 to perform a second access operation on the second streaming signal ST2, and using the third slave device 723 to perform a third access operation on the third streaming signal ST3. The analyses performed on the first streaming signal ST1, the second streaming signal ST2, and the third streaming signal ST3 by the slave device group 720 may be deduced from the embodiment of FIG. 4, and therefore no description will be further provided.

Referring to FIG. 7, the first slave device 721 may generate a first streaming response signal STR1 based on the first streaming signal ST1, and transmit the first streaming response signal STR1 to the master device 710 at a first time point via the sub-data transmission paths 702, 703, 704. The second slave device 722 may generate a second streaming response signal STR2 based on the second streaming signal ST2, and transmit the second streaming response signal STR2 to the master device 710 at a second time point via the sub-data transmission paths 703, 704. The third slave device 723 may generate a third streaming response signal STR3 based on the third streaming signal ST3, and transmit the third streaming response signal STR3 to the master device 710 at a third time point via the sub-data transmission path 704. The master device 710 may analyze the first streaming response signal STR1, the second streaming response signal STR2, and the third streaming response signal STR3 to respectively determine that the first streaming response signal STR1 is generated from the first slave device 721, determine that the second streaming response signal STR2 is generated from the second slave device 722, and determine that the third streaming response signal STR3 is generated from the third slave device 723. The analyses performed on the first streaming response signal STR1, the second streaming response signal STR2, and the third streaming response signal STR3 by the master device 710 may be deduced from the embodiment of FIG. 4, and therefore no description will be further provided.

In summary, in the embodiments of the disclosure, the data transmission system performs an identification operation between a master device and a target slave device by using a streaming signal transmitted from the mater device to the slave device group. In addition, the master device in the embodiments of the disclosure determines the one-to one mapping operation each of the slave devices and each of the streaming response signal, so that the master device performs an access operation on the data transmitted by a specific slave device. Since the master device and the slave device group are connected in series along a data transmission path based on the transmission operations of the streaming signals and the streaming response signals, the data transmission system and the data transmission method of the disclosure do not induce cross talk effects. Therefore, the data transmission system and the data transmission method of the disclosure may enhance the data transmission efficiency between the master device and multiple slave devices.

Although the disclosure has been disclosed by the above embodiments, they are not intended to limit the disclosure. It will be apparent to one of ordinary skill in the art that modifications and variations to the disclosure may be made without departing from the spirit and scope of the disclosure. Therefore, the scope of the disclosure will be defined by the appended claims.

What is claimed is:

1. A data transmission system, comprising:
a master device; and
a slave device group, comprising a first slave device and a second slave device, wherein the master device, the first slave device, and the second slave device are sequentially connected in series along a data transmission path,
wherein the master device is configured to transmit a streaming signal to the slave device group, and the slave device group is configured to analyze the streaming signal to identify which one of the first slave device and the second slave device is a target slave device for performing an access operation on the streaming signal,
wherein the target slave device is configured to generate a streaming response signal based on the streaming signal and transmit the streaming response signal to the master device,
wherein the master device is configured to analyze the streaming response signal to identify the streaming response signal is generated by the first slave device or the second slave device.

2. The data transmission system according to claim 1, wherein each of the streaming signal and the streaming response signal comprises feature information and data information,
wherein the slave device group is configured to identify the target device to perform a first access operation on the data information of the streaming signal by analyzing the feature information of the streaming signal,
wherein the master device is configured to identify the streaming response signal is generated by the first slave device or the second slave device by analyzing the feature information of the streaming response signal, and the master device is configured to perform a second access operation on the data information of the streaming response signal.

3. The data transmission system according to claim 2, wherein the feature information of the streaming signal is transmitted before the data information of the streaming signal, and the feature information of the streaming response signal is transmitted before the data information of the streaming response signal.

4. The data transmission system according to claim 1, wherein the data transmission path comprises a sub-data transmission path connecting from the second slave device to the master device, wherein the streaming response signal is transmitted to the master device via the sub-data transmission path.

5. The data transmission system according to claim 1, wherein the master device and the slave device group use a same clock signal.

6. A data transmission system, comprising:
a master device; and
a slave device group, comprising a first slave device and a second slave device, wherein the master device, the first slave device, and the second slave device are sequentially connected in series along a data transmission path,
wherein the master device is configured to respectively transmit a first streaming signal and a second streaming signal to the slave device group at different time points, and the slave device group is configured to analyze the first streaming signal and the second streaming signal to identify that using the first slave device to perform a first access operation on the first streaming signal and using the second slave device to perform a second access operation on the second streaming signal,
wherein the first slave device is configured to generate a first streaming response signal based on the first streaming signal and transmit the first streaming response signal to the master device at a first time point,
wherein the second slave device is configured to generate a second streaming response signal based on the second streaming signal and transmit the second streaming response signal to the master device at a second time point,
wherein the master device is configured to analyze the first streaming response signal and the second streaming response signal to identify that the first streaming response signal is generated from the first slave device and identify that the second streaming response signal is generated from the second slave device, respectively.

7. The data transmission system according to claim 6, wherein the first streaming signal and the second streaming signal do not overlap with each other on the data transmission path.

8. The data transmission system according to claim 7, wherein the data transmission path comprises a sub-data transmission path connecting from the second slave device to the master device, wherein each of the first streaming response signal and the second streaming response signal is transmitted to the master device via the sub-data transmission path.

9. The data transmission system according to claim 8, wherein the first streaming response signal and the second streaming response signal do not overlap with each other on the sub-data transmission path.

10. The data transmission system according to claim 8, wherein the first streaming signal comprises first feature information and first data information transmitted after the first feature information, and the second streaming signal comprises second feature information and second data information transmitted after the second feature information,
wherein the slave device group is configured to identify that using the first slave device to perform the first access operation on the first data information of the first streaming signal and using the second slave device to perform the second access operation on the second data information of the second streaming signal by analyzing the first feature information of the first streaming signal and the second feature information of the second streaming signal,
wherein the first streaming response signal comprises third feature information and third data information transmitted after the third feature information, and the second streaming response signal comprises fourth feature information and fourth data information transmitted after the fourth feature information,
wherein the master device is configured to respectively identify that the first streaming response signal is generated from the first slave device and identify that the second streaming response signal is generated from the second slave device by analyzing the third feature information of the first streaming response signal and the fourth feature information of the second streaming response signal.

11. The data transmission system according to claim 8, wherein the slave device group further comprises a third slave device, and the first slave device, the second slave device, and the third slave device are sequentially connected in series along a data transmission path,
wherein the master device is configured to respectively transmit the first streaming signal, the second streaming signal, and a third streaming signal to the slave device group at different time points, and the slave device group is configured to analyze the first streaming signal, the second streaming signal, and the third streaming signal to identify that using the third slave device to perform a third access operation on the third streaming signal,
wherein the third slave device is configured to generate a third streaming response signal based on the third streaming signal and transmit the third streaming response signal to the master device at a third time point,
wherein the master device is configured to analyze the first streaming response signal, the second streaming response signal, and the third streaming response signal to identify that the third streaming response signal is generated from the third slave device.

12. A method for transmitting data between a master device and a slave device group, wherein the slave device group comprises a first slave device and a second slave device, and the master device, the first slave device, and the second slave device are sequentially connected in series along a data transmission path, the method comprising:
respectively transmitting a first streaming signal and a second streaming signal to the slave device group at different time points by the master device, and analyzing the first streaming signal and the second streaming signal by the slave device group so as to identify that using the first slave device to perform a first access operation on the first streaming signal and using the second slave device to perform a second access operation on the second streaming signal;
generating a first streaming response signal based on the first streaming signal by the first slave device, and transmitting the first streaming response signal to the master device at a first time point;
generating a second streaming response signal based on the second streaming signal by the second slave device, and transmitting the second streaming response signal to the master device at a second time point; and
analyzing the first streaming response signal and the second streaming response signal by the master device to respectively identify that the first streaming response signal is generated from the first slave device and identify that the second streaming response signal is generated from the second slave device.

13. The method according to claim 12, wherein the first streaming signal and the second streaming signal do not overlap with each other on the data transmission path.

14. The method according to claim 13, wherein the data transmission path comprises a sub-data transmission path connecting from the second slave device to the master device, wherein each of the first streaming response signal and the second streaming response signal is transmitted to the master device via the sub-data transmission path.

15. The method according to claim 14, wherein the first streaming response signal and the second streaming response signal do not overlap with each other on the sub-data transmission path.

16. The method according to claim 14, wherein the first streaming signal comprises first feature information and first data information transmitted after the first feature information, and the second streaming signal comprises second feature information and second data information transmitted after the second feature information, wherein analyzing the first streaming signal and the second streaming signal by the slave device group so as to identify that using the first slave device to perform a first access operation on the first streaming signal and using the second slave device to perform a second access operation on the second streaming signal comprises:
identifying the first feature information of the first streaming signal and the second feature information of the second streaming signal by the slave device group so as to decide that using the first slave device to perform the first access operation on the first data information of the first streaming signal and using the second slave device to perform the second access operation on the second data information of the second streaming signal.

17. The method according to claim 16, wherein the first streaming response signal comprises third feature information and third data information transmitted after the third feature information, and the second streaming response signal comprises fourth feature information and fourth data information transmitted after the fourth feature information, wherein analyzing the first streaming response signal and the second streaming response signal by the master device to respectively determine that the first streaming response signal is generated from the first slave device and determine that the second streaming response signal is generated from the second slave device comprises:
identifying the third feature information of the first streaming response signal and the fourth feature information of the second streaming response signal by the master device to respectively determine that the first streaming response signal is generated from the first slave device and determine that the second streaming response signal is generated from the second slave device.
